(19) United States
(12) Patent Application Publication
(10) Pub. No.: US 2019/0147540 A1
(43) Pub. Date: May 16, 2019

(54) METHOD AND APPARATUS FOR OUTPUTTING INFORMATION

(71) Applicant: Baidu Online Network Technology (Beijing) Co., Ltd., Beijing (CN)

(72) Inventors: Mingyang Dai, Beijing (CN); Lei Han, Beijing (CN); Chuanxin Bian, Beijing (CN); Shengwen Yang, Beijing (CN)

(21) Appl. No.: 16/133,326

(22) Filed: Sep. 17, 2018

(30) Foreign Application Priority Data
Nov. 15, 2017 (CN) 201711132489.8

(51) Int. Cl. G06Q 40/08; H04L 29/08; G06N 99/00

(52) U.S. Cl. CPC G06Q 40/08; G06N 99/005; H04L 67/306; H04L 67/22

(57) ABSTRACT

Embodiments of the present disclosure disclose a method and apparatus for outputting information. A specific embodiment of the method includes: acquiring at least one personal attribute characteristic of a target user; determining, based on the acquired at least one personal attribute characteristic, a user type of the target user under a preset attribute; and outputting the determined user type. This embodiment effectively utilizes the personal attribute characteristic of the user to predict the user type of the user under the preset attribute, and improves the content richness of the information output.

### CROSS-REFERENCE TO RELATED APPLICATIONS

This application is related to and claims priority from Chinese Application No. 201711132489.8, filed on Nov. 15, 2017 and entitled “Method and Apparatus for Outputting Information,” the entire disclosure of which is hereby incorporated by reference.

### TECHNICAL FIELD

Embodiments of the present disclosure relate to the field of computer technology, specifically relate to the field of Internet technology, and more specifically relate to a method and apparatus for outputting information.

### BACKGROUND

With the development of the Internet and the data mining technology, currently, there are various kinds of user characteristic information obtained by data mining the user's Internet-related data.

### SUMMARY

Embodiments of the present disclosure propose a method and apparatus for outputting information.

In a first aspect, the embodiments of the present disclosure provide a method for outputting information, including: acquiring at least one personal attribute characteristic of a target user; determining, based on the acquired at least one personal attribute characteristic, a user type of the target user under a preset attribute; and outputting the determined user type.

In some embodiments, the at least one personal attribute characteristic includes at least one of the following: a natural personal attribute characteristic or a network behavior characteristic, and the network behavior characteristic includes at least one of the following: an electronic map navigation characteristic, an interests profile characteristic, an address characteristic, a common application characteristic, a credit score characteristic or a network search topic characteristic.

In some embodiments, the determining, based on the acquired at least one personal attribute characteristic, a user type of the target user under a preset attribute includes: importing the acquired at least one personal attribute characteristic into a pre-trained user type determination model to obtain the user type of the target user under the preset attribute, wherein the user type determination model is used to represent a corresponding relationship between the at least one personal attribute characteristic and the user type.

In some embodiments, the user type includes a first user type and a second user type.

In some embodiments, the determining, based on the acquired at least one personal attribute characteristic, a user type of the target user under a preset attribute includes: importing the acquired at least one personal attribute characteristic into a pre-trained vehicle accident occurrence frequency calculation model to obtain a predicted vehicle accident occurrence frequency of the target user, wherein the vehicle accident occurrence frequency calculation model is used to represent a corresponding relationship between the at least one personal attribute characteristic and a vehicle accident occurrence frequency; determining the user type of the target user under the preset attribute to be the first user type, in response to determining the predicted vehicle accident occurrence frequency being greater than a preset vehicle accident occurrence frequency threshold; and determining the user type of the target user under the preset attribute to be the second user type, in response to determining the predicted vehicle accident occurrence frequency being not greater than the preset vehicle accident occurrence frequency threshold.

In some embodiments, the determining, based on the acquired at least one personal attribute characteristic, a user type of the target user under a preset attribute includes: importing the acquired at least one personal attribute characteristic into a pre-trained vehicle accident compensation rate calculation model to obtain a predicted vehicle accident compensation rate of the target user, wherein the vehicle accident compensation rate calculation model is used to represent a corresponding relationship between the at least one personal attribute characteristic and a vehicle accident compensation rate; determining the user type of the target user under the preset attribute to be the first user type, in response to determining the predicted vehicle accident compensation rate being greater than a preset vehicle accident compensation rate threshold; and determining the user type of the target user under the preset attribute to be the second user type, in response to determining the predicted vehicle accident compensation rate being not greater than the preset vehicle accident compensation rate threshold.

In some embodiments, the user type determination model is trained and obtained by: acquiring an initial user type determination model and a predetermined first sample data set, wherein each piece of sample data in the first sample data set includes at least one personal attribute characteristic of a user and a user type of the user under the preset attribute; using the at least one personal attribute characteristic of the user in each piece of sample data in the first sample data set as input data, and the user type of the user under the preset attribute in the sample data as corresponding output data to train the initial user type determination model using a machine learning method; and defining the trained initial user type determination model as the pre-trained user type determination model.

In some embodiments, the vehicle accident occurrence frequency calculation model is trained and obtained by: acquiring an initial vehicle accident occurrence frequency calculation model and a predetermined second sample data set, wherein each piece of sample data in the second sample data set includes at least one personal attribute characteristic of a user and a historical vehicle accident occurrence frequency of the user; using the at least one personal attribute characteristic of the user in each piece of sample data in the second sample data set as input data, and the historical vehicle accident occurrence frequency of the user in the sample data as corresponding output data to train the initial vehicle accident occurrence frequency calculation model using a machine learning method; and defining the trained initial vehicle accident occurrence frequency calculation model as the pre-trained vehicle accident occurrence frequency calculation model.

In some embodiments, the vehicle accident compensation rate calculation model is trained and obtained by: acquiring an initial vehicle accident compensation rate calculation model and a predetermined third sample data set, wherein each piece of sample data in the third sample data set includes at least one personal attribute characteristic of a user and a historical vehicle accident compensation rate of the user; using the at least one personal attribute characteristic of the user in each piece of sample data in the third sample data set as input data, and the historical vehicle accident compensation rate of the user in the sample data as corresponding output data to train the initial vehicle accident compensation rate calculation model using a machine learning method; and defining the trained initial vehicle accident compensation rate calculation model as the pre-trained vehicle accident compensation rate calculation model.

In a second aspect, the embodiments of the present disclosure provide an apparatus for outputting information, including: an acquisition unit, configured to acquire at least one personal attribute characteristic of a target user; a determination unit, configured to determine, based on the acquired at least one personal attribute characteristic, a user type of the target user under a preset attribute; and an output unit, configured to output the determined user type.

In some embodiments, the at least one personal attribute characteristic includes at least one of the following: a natural personal attribute characteristic or a network behavior characteristic, and the network behavior characteristic includes at least one of the following: an electronic map navigation characteristic, an interests profile characteristic, an address characteristic, a common application characteristic, a credit score characteristic or a network search topic characteristic.

In some embodiments, the determination unit is further configured to: import the acquired at least one personal attribute characteristic into a pre-trained user type determination model to obtain the user type of the target user under the preset attribute, wherein the user type determination model is used to represent a corresponding relationship between the at least one personal attribute characteristic and the user type.

In some embodiments, the user type includes a first user type and a second user type.

In some embodiments, the determination unit is further configured to: import the acquired at least one personal attribute characteristic into a pre-trained vehicle accident occurrence frequency calculation model to obtain a predicted vehicle accident occurrence frequency of the target user, wherein the vehicle accident occurrence frequency calculation model is used to represent a corresponding relationship between the at least one personal attribute characteristic and a vehicle accident occurrence frequency; determine the user type of the target user under the preset attribute to be the first user type, in response to determining the predicted vehicle accident occurrence frequency being greater than a preset vehicle accident occurrence frequency threshold; and determine the user type of the target user under the preset attribute to be the second user type, in response to determining the predicted vehicle accident occurrence frequency being not greater than the preset vehicle accident occurrence frequency threshold.

In some embodiments, the determination unit is further configured to: import the acquired at least one personal attribute characteristic into a pre-trained vehicle accident compensation rate calculation model to obtain a predicted vehicle accident compensation rate of the target user, wherein the vehicle accident compensation rate calculation model is used to represent a corresponding relationship between the at least one personal attribute characteristic and a vehicle accident compensation rate; determine the user type of the target user under the preset attribute to be the first user type, in response to determining the predicted vehicle accident compensation rate being greater than a preset vehicle accident compensation rate threshold; and determine the user type of the target user under the preset attribute to be the second user type, in response to determining the predicted vehicle accident compensation rate being not greater than the preset vehicle accident compensation rate threshold.

In some embodiments, the user type determination model is trained and obtained by: acquiring an initial user type determination model and a predetermined first sample data set, wherein each piece of sample data in the first sample data set includes at least one personal attribute characteristic of a user and a user type of the user under the preset attribute; using the at least one personal attribute characteristic of the user in each piece of sample data in the first sample data set as input data, and the user type of the user under the preset attribute in the sample data as corresponding output data to train the initial user type determination model using a machine learning method; and defining the trained initial user type determination model as the pre-trained user type determination model.

In some embodiments, the vehicle accident occurrence frequency calculation model is trained and obtained by: acquiring an initial vehicle accident occurrence frequency calculation model and a predetermined second sample data set, wherein each piece of sample data in the second sample data set includes at least one personal attribute characteristic of a user and a historical vehicle accident occurrence frequency of the user; using the at least one personal attribute characteristic of the user in each piece of sample data in the second sample data set as input data, and the historical vehicle accident occurrence frequency of the user in the sample data as corresponding output data to train the initial vehicle accident occurrence frequency calculation model using a machine learning method; and defining the trained initial vehicle accident occurrence frequency calculation model as the pre-trained vehicle accident occurrence frequency calculation model.

In some embodiments, the vehicle accident compensation rate calculation model is trained and obtained by: acquiring an initial vehicle accident compensation rate calculation model and a predetermined third sample data set, wherein each piece of sample data in the third sample data set includes at least one personal attribute characteristic of a user and a historical vehicle accident compensation rate of the user; using the at least one personal attribute characteristic of the user in each piece of sample data in the third sample data set as input data, and the historical vehicle accident compensation rate of the user in the sample data as corresponding output data to train the initial vehicle accident compensation rate calculation model using a machine learning method; and defining the trained initial vehicle accident compensation rate calculation model as the pre-trained vehicle accident compensation rate calculation model.

In a third aspect, the embodiments of the present disclosure provide an electronic device, including: one or more processors; and a storage apparatus, for storing one or more programs, the one or more programs, when executed by the one or more processors, cause the one or more processors to implement the method according to any one of the embodiments in the first aspect.

In a fourth aspect, the embodiments of the present disclosure provide a computer readable storage medium, storing a computer program thereon, the program, when executed by a processor, implements the method according to any one of the embodiments in the first aspect.

The method and apparatus for outputting information provided by the embodiments of the present disclosure acquire at least one personal attribute characteristic of the target user, then determine the user type of the target user under the preset attribute based on the acquired at least one personal attribute characteristic, and finally output the determined user type, thereby effectively utilizing the personal attribute characteristic of the user to predict the user type of the user under the preset attribute, improving the content richness of the information output.

### BRIEF DESCRIPTION OF THE DRAWINGS

After reading detailed descriptions of non-limiting embodiments with reference to the following accompanying drawings, other features, objectives and advantages of the present disclosure will become more apparent:

FIG. 1 is an architecture diagram of an exemplary system in which the present disclosure may be implemented;

FIG. 2 is a flowchart of an embodiment of a method for outputting information according to the present disclosure;

FIG. 3 is a flowchart of another embodiment of the method for outputting information according to the present disclosure;

FIG. 4 is a flowchart of yet another embodiment of the method for outputting information according to the present disclosure;

FIG. 5 is a schematic structural diagram of an embodiment of an apparatus for outputting information according to the present disclosure; and

FIG. 6 is a schematic structural diagram of a computer system adapted to implement an electronic device of embodiments of the present disclosure.

### DETAILED DESCRIPTION OF EMBODIMENTS

The present disclosure will be further described below in detail in combination with the accompanying drawings and the embodiments. It should be appreciated that the specific embodiments described herein are merely used for explaining the relevant disclosure, rather than limiting the disclosure. In addition, it should be noted that, for the ease of description, only the parts related to the relevant disclosure are shown in the accompanying drawings.

It should be noted that the embodiments in the present disclosure and the features in the embodiments may be combined with each other on a non-conflict basis. The present disclosure will be described below in detail with reference to the accompanying drawings and in combination with the embodiments.

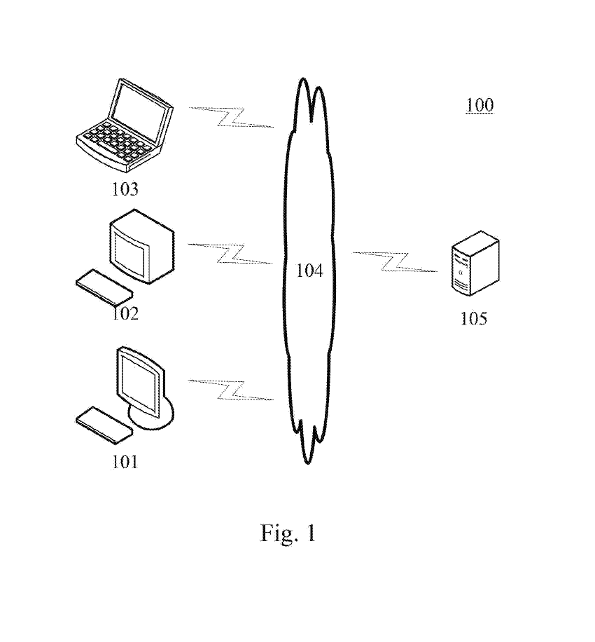

FIG. 1 shows an architecture of an exemplary system 100 which may be used by a method for outputting information or an apparatus for outputting information according to the embodiments of the present disclosure.

As shown in FIG. 1, the system architecture 100 may include terminal devices 101, 102 and 103, a network 104 and a server 105. The network 104 serves as a medium providing a communication link between the terminal devices 101, 102 and 103, and the server 105. The network 104 may include various types of connections, such as wired or wireless transmission links, or optical fibers.

The user may use the terminal devices 101, 102 and 103 to interact with the server 105 through the network 104, in order to transmit or receive messages, etc. Various client applications, such as vehicle insurance risk prediction applications, webpage browser applications, shopping applications, search applications, instant messaging tools, mailbox clients, and social platform software may be installed on the terminal devices 101, 102 and 103.

The terminals 101, 102 and 103 may be various electronic devices having display screens, including but not limited to, smart phones, tablet computers, laptop computers, and desktop computers.

The server 105 may be a server providing various services, for example, a backend server providing support for vehicle insurance risk prediction applications displayed on the terminal devices 101, 102 or 103. The backend server may perform processing such as analyzing on data such as received data acquiring request, and return a processing result (for example, a personal attribute characteristic) to the terminal devices.

It should be noted that the method for outputting information according to the embodiments of the present disclosure is generally executed by the terminal devices 101, 102 or 103. Accordingly, the apparatus for outputting information is generally installed on the terminal devices 101, 102 or 103.

It should be appreciated that the numbers of the terminal devices, the networks and the servers in FIG. 1 are merely illustrative. Any number of terminal devices, networks and servers may be provided based on the actual requirements.

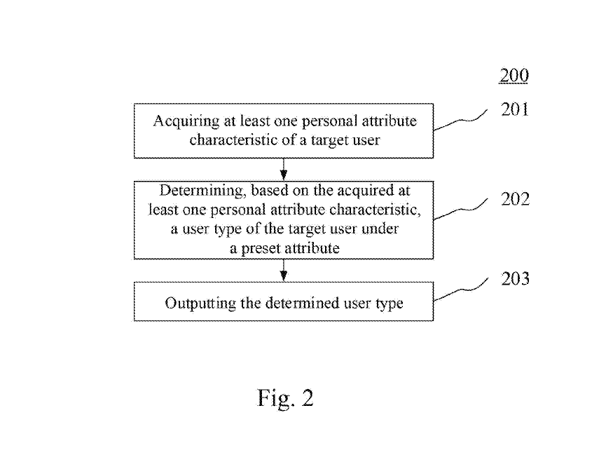

With further reference to FIG. 2, a flow 200 of an embodiment of the method for outputting information according to the present disclosure is illustrated. The method for outputting information includes the following steps.

Step 201, acquiring at least one personal attribute characteristic of a target user.

In the present embodiment, the electronic device (e.g., the terminal device as shown in FIG. 1) on which the method for outputting information is performed may acquire at least one personal attribute characteristic of a target user locally or remotely from other electronic devices (e.g., the server as shown in FIG. 1) connected to the electronic device via a network. At least one personal attribute characteristic of the target user may be stored in the electronic device locally or in other electronic devices connected to the electronic device via the network.

In the present embodiment, the target user may be any specified user in a preset user set, and the personal attribute characteristic of the specified user may be acquired.

In the present embodiment, the personal attribute characteristic of the target user is a characteristic obtained by performing characteristic extraction on attribute values of various attributes of the target user as a person. For example, attributes of a person may include name, gender, date of birth, cell phone number, occupation, income, hobbies, residential city, driving habits, and the like. As an example, the personal attribute characteristic may be a user underlying characteristic that is unearthed by performing processing such as collecting, storing, processing, analyzing, monitoring, and alerting on big data in advance.

In some alternative implementations of the present embodiment, the at least one personal attribute characteristic may include at least one of the following: a natural personal attribute characteristic or a network behavior characteristic. Here, the natural personal attribute characteristic may be a characteristic obtained by performing characteristic extraction on attribute values of natural attributes of a natural person. For example, the natural attributes may be attributes associated with a person's own biological characteristics such as date of birth, gender, and physical condition. The network behavior characteristic may be a characteristic obtained by performing characteristic extraction on behavior data of the user on the network, for example, data of an electronic map used by the user for navigation, webpage browsed and keyword inputted by the user on a website, shopping data and evaluation data of the user using an E-shopping application, payment data of the user using a payment application, and input information of the user on a car related website, etc. Here, the network behavior characteristic may include at least one of the following: an electronic map navigation characteristic, an interests profile characteristic, an address characteristic, a common application characteristic, a credit score characteristic or a network search topic characteristic. Alternatively, the electronic map navigation characteristic may include, but is not limited to, at least one of the following: mileage, fatigue during driving, frequency of sudden acceleration, frequency of sudden deceleration, frequency of sharp turns, urban portrait, weather, backlight driving, road type, electronic eye, viaduct and intersection type. Here, the mileage may be the sum of the distance between the destination and the place of departure for each navigation of the user using the electronic map for navigation within a preset time. Fatigue during driving may be judged by the time and frequency of the user using the electronic map for navigation. The frequency of sudden acceleration, frequency of sudden deceleration, and frequency of sharp turns may also be obtained by statistical analysis of positioning information of the user terminal during the process of using the electronic map for navigation by the user. Similarly, other electronic map navigation characteristics may be obtained by navigation information during the process of using the electronic map for navigation by the user and the positioning information of the user terminal.

Step 202, determining, based on the acquired at least one personal attribute characteristic, a user type of the target user under a preset attribute.

In the present embodiment, based on the at least one personal attribute characteristic obtained in step 201, the electronic device may determine the user type of the target user under the preset attribute based on the acquired at least one personal attribute characteristic.

In some alternative implementations of the present embodiment, the preset attribute may be an attribute corresponding to one of the at least one personal attribute characteristic. For example, when the at least one personal attribute characteristic includes an age attribute characteristic, the user type of the user under the “age group” attribute may be determined based on the at least one personal attribute characteristic. For example, the user type of the user under the “age group” attribute may include but is not limited to: infants, toddlers, children, teenagers, youth, middle age and senior citizens. For another example, when the at least one personal attribute characteristic includes the city attribute characteristic, the user type of the user under the “city type” attribute may be determined based on the at least one personal attribute characteristic, for example, the user type of the user under the “city type” attribute may include but is not limited to: super cities, megacities, big cities, medium cities, and small cities.

In some alternative implementations of the present embodiment, the preset attribute may also be an attribute that can obtain an attribute value after analyzing and processing the at least one personal attribute characteristic. For example, the technical personnel may define a corresponding relationship table based on statistics of a large number of at least one of personal attribute characteristics and the corresponding user types under the preset attribute, where the corresponding relationships between the at least one of personal attribute characteristics and the user types under the preset attribute are stored in the corresponding relationship table. In this way, the electronic device may query the user type under the preset attribute that matches the at least one personal attribute characteristic of the target user in the corresponding relationship table, and define the found user type as the user type of the target user in the preset attribute. For another example, a calculation formula for numerically calculating one or more values of the at least one personal attribute characteristics may also be preset by a technical personnel based on statistics on a large amount of data, and the acquired at least one personal attribute characteristic of the target user may be substituted into the calculation formula to obtain the user type of the target user under the preset attribute.

In some alternative implementations of the present embodiment, the electronic device may also import the acquired at least one personal attribute characteristic into a pre-trained user type determination model to obtain the user type of the target user under the preset attribute. Here, the user type determination model is used to represent a corresponding relationship between the at least one personal attribute characteristic and the user type. For example, the user type determination model may be a corresponding relationship table pre-defined by a technical personnel based on statistics on a large number of at least one of personal attribute characteristics and user types of the user under the preset attribute, storing corresponding relationships between a plurality of at least one of personal attribute characteristics and user types of the user under the preset attribute. The user type determination model may also be a calculation formula for representing the user type of the user under the preset attribute obtained by numerically calculating one or more values of the at least one personal attribute characteristic, preset by a technical personnel based on statistics on a large amount of data and stored into the electronic device.

In some alternative implementations of the present embodiment, the user type determination model may be trained and obtained by the following first training steps.

First, an initial user type determination model and a predetermined first sample data set may be acquired. Here, each piece of sample data in the first sample data set includes at least one personal attribute characteristic of a user and a user type of the user under the preset attribute. For example, the user type of the user under the preset attribute may be manually annotated.

Then, the at least one personal attribute characteristic of the user in each piece of sample data in the first sample data set may be used as input data, and the user type of the user under the preset attribute in the sample data may be used as corresponding output data to train the initial user type determination model using a machine learning method.

Finally, the trained initial user type determination model may be defined as the pre-trained user type determination model.

Here, the user type determination model may be various machine learning models, for example, may be a Binary Classification model, a Logistic Regression model, or the like.

Step 203, outputting the determined user type.

In the present embodiment, the electronic device may output the user type determined in step 202.

In some alternative implementations of the present embodiment, the determined user type may be presented in the electronic device (e.g., in a display screen of the electronic device).

In some alternative implementations of the present embodiment, the electronic device may also send the determined user type to other electronic devices connected to the electronic device via the network, for the other electronic devices to receive and present the determined user type.

The method provided by the embodiments of the present disclosure acquires at least one personal attribute characteristic of the target user, then determines the user type of the target user under the preset attribute based on the acquired at least one personal attribute characteristic, and finally outputs the determined user type, thereby effectively utilizing the personal attribute characteristic of the user to predict the user type of the user under the preset attribute, and improving the content richness of the information output.

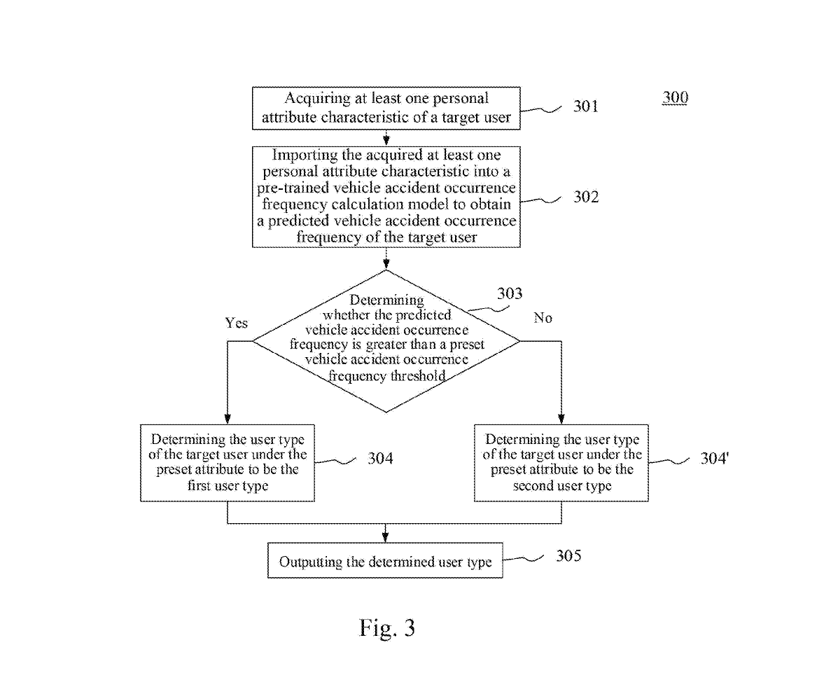

With further reference to FIG. 3, a flow 300 of another embodiment of the method for outputting information according to the present disclosure is illustrated. The flow 300 of the method for outputting information includes the following steps.

Step 301, acquiring at least one personal attribute characteristic of a target user.

In the present embodiment, the specific operation of step 301 is substantially the same as the operation of step 201 in the embodiment shown in FIG. 2, and detailed description thereof will be omitted.

Step 302, importing the acquired at least one personal attribute characteristic into a pre-trained vehicle accident occurrence frequency calculation model to obtain a predicted vehicle accident occurrence frequency of the target user.

In the present embodiment, the electronic device (e.g., the terminal device as shown in FIG. 1) on which the method for outputting information is performed may import the at least one personal attribute characteristic acquired in step 301 into a pre-trained vehicle accident occurrence frequency calculation model to obtain a predicted vehicle accident occurrence frequency of the target user. Here, the vehicle accident occurrence frequency calculation model is used to represent a corresponding relationship between the at least one personal attribute characteristic and a vehicle accident occurrence frequency. For example, the vehicle accident occurrence frequency calculation model may be a corresponding relationship table pre-defined by a technical personnel based on statistics on a large number of at least one of personal attribute characteristics and vehicle accident occurrence frequencies (e.g., the frequencies of the vehicle in danger), and storing corresponding relationships between a plurality of at least one of personal attribute characteristics and the vehicle accident occurrence frequencies. The vehicle accident occurrence frequency calculation model may also be a calculation formula for representing the vehicle accident occurrence frequency obtained by numerically calculating one or more values of the at least one personal attribute characteristic, preset by a technical personnel based on statistics on a large amount of data and stored into the electronic device.

In some alternative implementations of the present embodiment, the vehicle accident occurrence frequency calculation model may be trained and obtained by the following second training steps.

First, an initial vehicle accident occurrence frequency calculation model and a predetermined second sample data set may be acquired. Here, each piece of sample data in the second sample data set includes at least one personal attribute characteristic of a user and a historical vehicle accident occurrence frequency of the user (e.g., a historical frequency of the vehicle in danger).

Then, the at least one personal attribute characteristic of the user in each piece of sample data in the second sample data set may be used as input data, and the historical vehicle accident occurrence frequency of the user in the sample data may be used as corresponding output data to train the initial vehicle accident occurrence frequency calculation model using the machine learning method.

Finally, the trained initial vehicle accident occurrence frequency calculation model may be defined as the pre-trained vehicle accident occurrence frequency calculation model.

Here, the user type determination model may be various machine learning models, for example, may be a Binary Classification model, a Logistic Regression model, or the like.

Step 303, determining whether the predicted vehicle accident occurrence frequency is greater than a preset vehicle accident occurrence frequency threshold.

In the present embodiment, the electronic device may determine whether the predicted vehicle accident occurrence frequency determined in step 302 is greater than a preset vehicle accident occurrence frequency threshold. If the predicted vehicle accident occurrence frequency is greater than the threshold, the flow proceeds to step 304, if the predicted vehicle accident occurrence frequency is not greater than the threshold, the flow proceeds to step 304′.

Step 304, determining the user type of the target user under the preset attribute to be the first user type.

In the present embodiment, the user type of the user under the preset attribute may include a first user type and a second user type. For example, the first user type may be used to represent high risk users among vehicle insurance users, while the second user type may be used to represent low risk users among vehicle insurance users. In this way, the electronic device may determine the user type of the target user under the preset attribute to be the first user type, in response to determining the predicted vehicle accident occurrence frequency being greater than the preset vehicle accident occurrence frequency threshold in step 303. After step 304 is performed, the flow proceeds to step 305.

Step 304′, determining the user type of the target user under the preset attribute to be the second user type.

In the present embodiment, the electronic device may determine the user type of the target user under the preset attribute to be the second user type, in response to determining the predicted vehicle accident occurrence frequency being not greater than the preset vehicle accident occurrence frequency threshold in step 303. After step 304′ is performed, the flow proceeds to step 305.

Step 305, outputting the determined user type.

In the present embodiment, the specific operation of step 305 is substantially the same as the operation of step 203 in the embodiment shown in FIG. 2, and detailed description thereof will be omitted.

As can be seen from FIG. 3, compared with the corresponding embodiment of FIG. 2, the flow 300 of the method for outputting information in the present embodiment highlights the step of calculating the predicted vehicle accident occurrence frequency, comparing the predicted vehicle accident occurrence frequency with the preset vehicle accident occurrence frequency threshold and determining the user type of the target user under the preset attribute based on the comparison result. Therefore, the solution described in the present embodiment may determine the user type of the user under the preset attribute according to the predicted vehicle accident occurrence frequency of the user, thereby implementing generating to-be-outputted information in a plurality of ways.

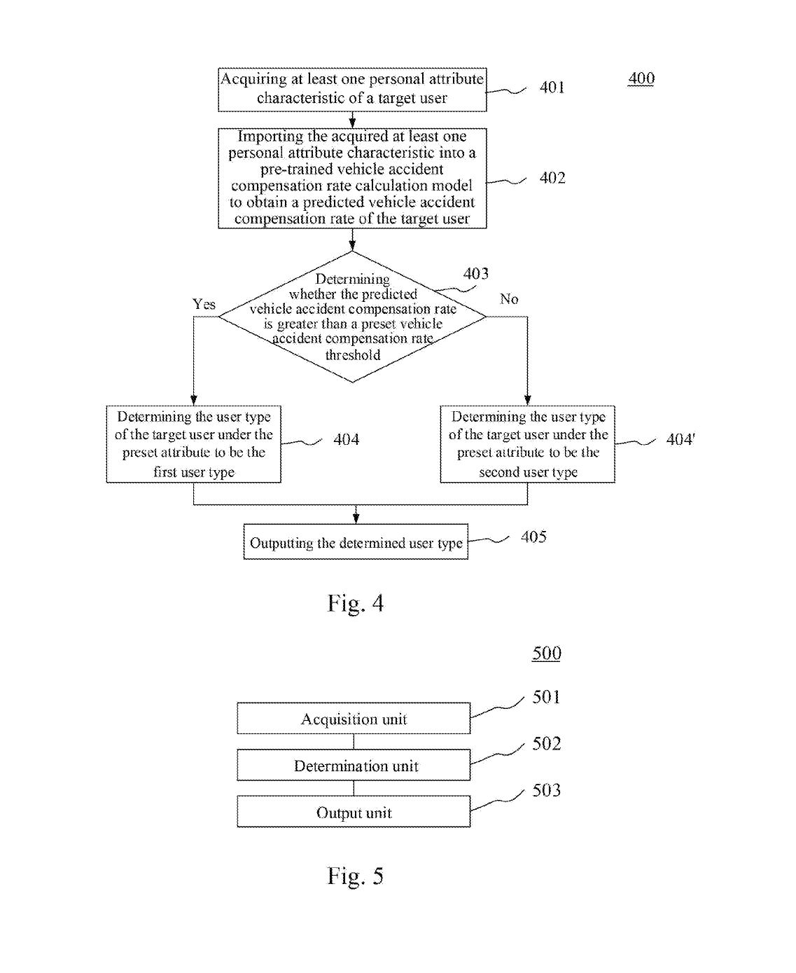

With further reference to FIG. 4, a flow 400 of yet another embodiment of the method for outputting information according to the present disclosure is illustrated. The flow 400 of the method for outputting information includes the following steps.

Step 401, acquiring at least one personal attribute characteristic of a target user.

In the present embodiment, the specific operation of step 401 is substantially the same as the operation of step 201 in the embodiment shown in FIG. 2, and detailed description thereof will be omitted.

Step 402, importing the acquired at least one personal attribute characteristic into a pre-trained vehicle accident compensation rate calculation model to obtain a predicted vehicle accident compensation rate of the target user.

In the present embodiment, the electronic device (e.g., the terminal device as shown in FIG. 1) on which the method for outputting information is performed may import the at least one personal attribute characteristic acquired in step 401 into a pre-trained vehicle accident compensation rate calculation model to obtain a predicted vehicle accident compensation rate of the target user. Here, the vehicle accident compensation rate calculation model is used to represent a corresponding relationship between the at least one personal attribute characteristic and a vehicle accident compensation rate (vehicle insurance compensation rate). For example, the vehicle accident compensation rate calculation model may be a corresponding relationship table pre-defined by a technical personnel based on statistics on a large number of at least one of personal attribute characteristics and vehicle accident compensation rates (e.g., the vehicle insurance compensation rate), and storing corresponding relationships between a plurality of at least one of personal attribute characteristics and the vehicle accident compensation rates. The vehicle accident compensation rate calculation model may also be a calculation formula for representing the vehicle accident compensation rate obtained by numerically calculating one or more values of the at least one personal attribute characteristic, preset by a technical personnel based on statistics on a large amount of data and stored into the electronic device.

In some alternative implementations of the present embodiment, the vehicle accident compensation rate calculation model may be trained and obtained by the following third training steps.

First, an initial vehicle accident compensation rate calculation model and a predetermined third sample data set may be acquired. Here, each piece of sample data in the third sample data set includes at least one personal attribute characteristic of a user and a historical vehicle accident compensation rate of the user (e.g., a historical vehicle insurance compensation rate).

Then, the at least one personal attribute characteristic of the user in each piece of sample data in the third sample data set may be used as input data, and the historical vehicle accident compensation rate of the user in the sample data may be used as corresponding output data to train the initial vehicle accident compensation rate calculation model using the machine learning method.

Finally, the trained initial vehicle accident compensation rate calculation model may be defined as the pre-trained vehicle accident compensation rate calculation model.

Here, the vehicle accident compensation rate calculation model may be various machine learning models, for example, may be a Logistic Regression model.

Step 403, determining whether the predicted vehicle accident compensation rate is greater than a preset vehicle accident compensation rate threshold.

In the present embodiment, the electronic device may determine whether the predicted vehicle accident compensation rate determined in step 402 is greater than a preset vehicle accident compensation rate threshold. If the predicted vehicle accident compensation rate is greater than the threshold, the flow proceeds to step 404, if the predicted vehicle accident compensation rate is not greater than the threshold, the flow proceeds to step 404′.

Step 404, determining the user type of the target user under the preset attribute to be the first user type.

In the present embodiment, the user type of the user under the preset attribute may include a first user type and a second user type. For example, the first user type may be used to represent high risk users among vehicle insurance users, while the second user type may be used to represent low risk users among vehicle insurance users. In this way, the electronic device may determine the user type of the target user under the preset attribute to be the first user type, in response to determining the predicted vehicle accident compensation rate being greater than the preset vehicle accident compensation rate threshold in step 403. After step 404 is performed, the flow proceeds to step 405.

Step 404′, determining the user type of the target user under the preset attribute to be the second user type.

In the present embodiment, the electronic device may determine the user type of the target user under the preset attribute to be the second user type, in response to determining the predicted vehicle accident compensation rate being not greater than the preset vehicle accident compensation rate threshold in step 403. After step 404′ is performed, the flow proceeds to step 405.

Step 405, outputting the determined user type.

In the present embodiment, the specific operation of step 405 is substantially the same as the operation of step 203 in the embodiment shown in FIG. 2, and detailed description thereof will be omitted.

As can be seen from FIG. 4, compared with the corresponding embodiment of FIG. 2, the flow 400 of the method for outputting information in the present embodiment highlights the step of calculating the predicted vehicle accident compensation rate, comparing the predicted vehicle accident compensation rate with the preset vehicle accident compensation rate threshold and determining the user type of the target user under the preset attribute based on the comparison result. Therefore, the solution described in the present embodiment may determine the user type of the user under the preset attribute according to the predicted vehicle accident compensation rate of the user, thereby implementing generating to-be-outputted information in a plurality of ways.

With further reference to FIG. 5, as an implementation to the method shown in the above figures, the present disclosure provides an embodiment of an apparatus for outputting information. The apparatus embodiment corresponds to the method embodiment shown in FIG. 2, and the apparatus may specifically be applied to various electronic devices.

As shown in FIG. 5, the apparatus 500 for outputting information of the present embodiment includes: an acquisition unit 501, a determination unit 502 and an output unit 503. The acquisition unit 501 is configured to acquire at least one personal attribute characteristic of a target user. The determination unit 502 is configured to determine, based on the acquired at least one personal attribute characteristic, a user type of the target user under a preset attribute. The output unit 503 is configured to output the determined user type.

In the present embodiment, the specific processing and the technical effects thereof of the acquisition unit 501, the determination unit 502 and the output unit 503 of the apparatus 500 for outputting information may be referred to the related descriptions of step 201, step 202, and step 203 in the corresponding embodiment of FIG. 2, respectively, and detailed description thereof will be omitted.

In some alternative implementations of the present embodiment, the at least one personal attribute characteristic may include at least one of the following: a natural personal attribute characteristic or a network behavior characteristic, and the network behavior characteristic may include at least one of the following: an electronic map navigation characteristic, an interests profile characteristic, an address characteristic, a common application characteristic, a credit score characteristic or a network search topic characteristic.

In some alternative implementations of the present embodiment, the determination unit 502 may be further configured to: import the acquired at least one personal attribute characteristic into a pre-trained user type determination model to obtain the user type of the target user under the preset attribute, wherein the user type determination model is used to represent a corresponding relationship between the at least one personal attribute characteristic and the user type.

In some alternative implementations of the present embodiment, the user type may include a first user type and a second user type.

In some alternative implementations of the present embodiment, the determination unit 502 may be further configured to: import the acquired at least one personal attribute characteristic into a pre-trained vehicle accident occurrence frequency calculation model to obtain a predicted vehicle accident occurrence frequency of the target user, wherein the vehicle accident occurrence frequency calculation model is used to represent a corresponding relationship between the at least one personal attribute characteristic and a vehicle accident occurrence frequency; determine the user type of the target user under the preset attribute to be the first user type, in response to determining the predicted vehicle accident occurrence frequency being greater than a preset vehicle accident occurrence frequency threshold; and determine the user type of the target user under the preset attribute to be the second user type, in response to determining the predicted vehicle accident occurrence frequency being not greater than the preset vehicle accident occurrence frequency threshold.

In some alternative implementations of the present embodiment, the determination unit 502 may be further configured to: import the acquired at least one personal attribute characteristic into a pre-trained vehicle accident compensation rate calculation model to obtain a predicted vehicle accident compensation rate of the target user, wherein the vehicle accident compensation rate calculation model is used to represent a corresponding relationship between the at least one personal attribute characteristic and a vehicle accident compensation rate; determine the user type of the target user under the preset attribute to be the first user type, in response to determining the predicted vehicle accident compensation rate being greater than a preset vehicle accident compensation rate threshold; and determine the user type of the target user under the preset attribute to be the second user type, in response to determining the predicted vehicle accident compensation rate being not greater than the preset vehicle accident compensation rate threshold.

In some alternative implementations of the present embodiment, the user type determination model may be trained and obtained by: acquiring an initial user type determination model and a predetermined first sample data set, wherein each piece of sample data in the first sample data set includes at least one personal attribute characteristic of a user and a user type of the user under the preset attribute; using the at least one personal attribute characteristic of the user in each piece of sample data in the first sample data set as input data, and the user type of the user under the preset attribute in the sample data as corresponding output data to train the initial user type determination model using a machine learning method; and defining the trained initial user type determination model as the pre-trained user type determination model.

In some alternative implementations of the present embodiment, the vehicle accident occurrence frequency calculation model may be trained and obtained by: acquiring an initial vehicle accident occurrence frequency calculation model and a predetermined second sample data set, wherein each piece of sample data in the second sample data set includes at least one personal attribute characteristic of a user and a historical vehicle accident occurrence frequency of the user; using the at least one personal attribute characteristic of the user in each piece of sample data in the second sample data set as input data, and the historical vehicle accident occurrence frequency of the user in the sample data as corresponding output data to train the initial vehicle accident occurrence frequency calculation model using a machine learning method; and defining the trained initial vehicle accident occurrence frequency calculation model as the pre-trained vehicle accident occurrence frequency calculation model.

In some alternative implementations of the present embodiment, the vehicle accident compensation rate calculation model may be trained and obtained by: acquiring an initial vehicle accident compensation rate calculation model and a predetermined third sample data set, wherein each piece of sample data in the third sample data set includes at least one personal attribute characteristic of a user and a historical vehicle accident compensation rate of the user; using the at least one personal attribute characteristic of the user in each piece of sample data in the third sample data set as input data, and the historical vehicle accident compensation rate of the user in the sample data as corresponding output data to train the initial vehicle accident compensation rate calculation model using a machine learning method; and defining the trained initial vehicle accident compensation rate calculation model as the pre-trained vehicle accident compensation rate calculation model.

It should be noted that the implementation details and technical effects of the units in the apparatus for outputting information provided by the embodiments of the present disclosure may be referred to the description of other embodiments in the present disclosure, and detailed description thereof will be omitted.

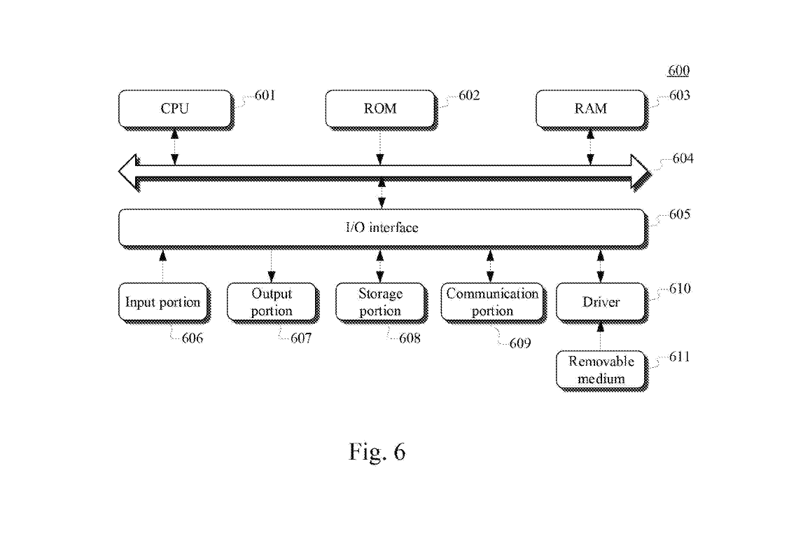

Referring to FIG. 6, a structural schematic diagram of a computer system 600 adapted to implement an electronic device of embodiments of the present disclosure is shown. The electronic device shown in FIG. 6 is merely an example, and should not bring any limitations to the functions and the scope of use of the embodiments of the present disclosure.

As shown in FIG. 6, the computer system 600 includes a central processing unit (CPU) 601, which may execute various appropriate actions and processes in accordance with a program stored in a read-only memory (ROM) 602 or a program loaded into a random access memory (RAM) 603 from a storage portion 608. The RAM 603 also stores various programs and data required by operations of the system 600. The CPU 601, the ROM 602 and the RAM 603 are connected to each other through a bus 604. An input/output (I/O) interface 605 is also connected to the bus 604.

The following components are connected to the I/O interface 605: an input portion 606 including a keyboard, a mouse etc.; an output portion 607 comprising a cathode ray tube (CRT), a liquid crystal display device (LCD), a speaker etc.; a storage portion 608 including a hard disk and the like; and a communication portion 609 comprising a network interface card, such as a LAN card and a modem. The communication portion 609 performs communication processes via a network, such as the Internet. A driver 610 is also connected to the I/O interface 605 as required. A removable medium 611, such as a magnetic disk, an optical disk, a magneto-optical disk, and a semiconductor memory, may be installed on the driver 610, to facilitate the retrieval of a computer program from the removable medium 611, and the installation thereof on the storage portion 608 as needed.

In particular, according to embodiments of the present disclosure, the process described above with reference to the flow chart may be implemented in a computer software program. For example, an embodiment of the present disclosure includes a computer program product, which comprises a computer program that is tangibly embedded in a machine-readable medium. The computer program comprises program codes for executing the method as illustrated in the flow chart. In such an embodiment, the computer program may be downloaded and installed from a network via the communication portion 609, and/or may be installed from the removable media 611. The computer program, when executed by the central processing unit (CPU) 601, implements the above mentioned functionalities as defined by the methods of the present disclosure. It should be noted that the computer readable medium in the present disclosure may be computer readable signal medium or computer readable storage medium or any combination of the above two. An example of the computer readable storage medium may include, but not limited to: electric, magnetic, optical, electromagnetic, infrared, or semiconductor systems, apparatus, elements, or a combination any of the above. A more specific example of the computer readable storage medium may include but is not limited to: electrical connection with one or more wire, a portable computer disk, a hard disk, a random access memory (RAM), a read only memory (ROM), an erasable programmable read only memory (EPROM or flash memory), a fibre, a portable compact disk read only memory (CD-ROM), an optical memory, a magnet memory or any suitable combination of the above. In the present disclosure, the computer readable storage medium may be any physical medium containing or storing programs which can be used by a command execution system, apparatus or element or incorporated thereto. In the present disclosure, the computer readable signal medium may include data signal in the base band or propagating as parts of a carrier, in which computer readable program codes are carried. The propagating signal may take various forms, including but not limited to: an electromagnetic signal, an optical signal or any suitable combination of the above. The signal medium that can be read by computer may be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium including but not limited to: wireless, wired, optical cable, RF medium etc., or any suitable combination of the above.

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion comprising one or more executable instructions for implementing specified logic functions. It should also be noted that, in some alternative implementations, the functions denoted by the blocks may occur in a sequence different from the sequences shown in the figures. For example, any two blocks presented in succession may be executed, substantially in parallel, or they may sometimes be in a reverse sequence, depending on the function involved. It should also be noted that each block in the block diagrams and/or flow charts as well as a combination of blocks may be implemented using a dedicated hardware-based system executing specified functions or operations, or by a combination of a dedicated hardware and computer instructions.

The units involved in the embodiments of the present disclosure may be implemented by means of software or hardware. The described units may also be provided in a processor, for example, described as: a processor, comprising an acquisition unit, a determination unit, and an output unit, where the names of these units do not in some cases constitute a limitation to such units themselves. For example, the output unit may also be described as “a unit for outputting the determined user type.”

In another aspect, the present disclosure further provides a computer-readable storage medium. The computer-readable storage medium may be the computer storage medium included in the apparatus in the above described embodiments, or a stand-alone computer-readable storage medium not assembled into the apparatus. The computer-readable storage medium stores one or more programs. The one or more programs, when executed by an apparatus, cause the apparatus to: acquiring at least one personal attribute characteristic of a target user; determining, based on the acquired at least one personal attribute characteristic, a user type of the target user under a preset attribute; and outputting the determined user type.

The above description only provides an explanation of the preferred embodiments of the present disclosure and the technical principles used. It should be appreciated by those skilled in the art that the inventive scope of the present disclosure is not limited to the technical solutions formed by the particular combinations of the above-described technical features. The inventive scope should also cover other technical solutions formed by any combinations of the above-described technical features or equivalent features thereof without departing from the concept of the disclosure. Technical schemes formed by the above-described features being interchanged with, but not limited to, technical features with similar functions disclosed in the present disclosure are examples.

What is claimed is:

1. A method for outputting information, the method comprising:
acquiring at least one personal attribute characteristic of a target user;
determining, based on the acquired at least one personal attribute characteristic, a user type of the target user under a preset attribute; and
outputting the determined user type.

2. The method according to claim 1, wherein the at least one personal attribute characteristic comprises at least one of: a natural personal attribute characteristic or a network behavior characteristic, and the network behavior characteristic comprises at least one of: an electronic map navigation characteristic, an interests profile characteristic, an address characteristic, a common application characteristic, a credit score characteristic or a network search topic characteristic.

3. The method according to claim 2, wherein the determining, based on the acquired at least one personal attribute characteristic, a user type of the target user under a preset attribute comprises:
importing the acquired at least one personal attribute characteristic into a pre-trained user type determination model to obtain the user type of the target user under the preset attribute, wherein the user type determination model is used to represent a corresponding relationship between the at least one personal attribute characteristic and the user type.

4. The method according to claim 2, wherein the user type comprises a first user type and a second user type.

5. The method according to claim 4, wherein the determining, based on the acquired at least one personal attribute characteristic, a user type of the target user under a preset attribute comprises:
importing the acquired at least one personal attribute characteristic into a pre-trained vehicle accident occurrence frequency calculation model to obtain a predicted vehicle accident occurrence frequency of the target user, wherein the vehicle accident occurrence frequency calculation model is used to represent a corresponding relationship between the at least one personal attribute characteristic and a vehicle accident occurrence frequency;
determining the user type of the target user under the preset attribute to be the first user type, in response to determining the predicted vehicle accident occurrence frequency being greater than a preset vehicle accident occurrence frequency threshold; and
determining the user type of the target user under the preset attribute to be the second user type, in response to determining the predicted vehicle accident occurrence frequency being not greater than the preset vehicle accident occurrence frequency threshold.

6. The method according to claim 4, wherein the determining, based on the acquired at least one personal attribute characteristic, a user type of the target user under a preset attribute comprises:
importing the acquired at least one personal attribute characteristic into a pre-trained vehicle accident compensation rate calculation model to obtain a predicted vehicle accident compensation rate of the target user, wherein the vehicle accident compensation rate calculation model is used to represent a corresponding relationship between the at least one personal attribute characteristic and a vehicle accident compensation rate;
determining the user type of the target user under the preset attribute to be the first user type, in response to determining the predicted vehicle accident compensation rate being greater than a preset vehicle accident compensation rate threshold; and
determining the user type of the target user under the preset attribute to be the second user type, in response to determining the predicted vehicle accident compensation rate being not greater than the preset vehicle accident compensation rate threshold.

7. The method according to claim 3, wherein the user type determination model is trained and obtained by:
acquiring an initial user type determination model and a predetermined first sample data set, wherein each piece of sample data in the first sample data set comprises at least one personal attribute characteristic of a user and a user type of the user under the preset attribute;
using the at least one personal attribute characteristic of the user in each piece of sample data in the first sample data set as input data, and the user type of the user under the preset attribute in the sample data as corresponding output data to train the initial user type determination model using a machine learning method; and
defining the trained initial user type determination model as the pre-trained user type determination model.

8. The method according to claim 5, wherein the vehicle accident occurrence frequency calculation model is trained and obtained by:
acquiring an initial vehicle accident occurrence frequency calculation model and a predetermined second sample data set, wherein each piece of sample data in the second sample data set comprises at least one personal attribute characteristic of a user and a historical vehicle accident occurrence frequency of the user;
using the at least one personal attribute characteristic of the user in each piece of sample data in the second sample data set as input data, and the historical vehicle accident occurrence frequency of the user in the sample data as corresponding output data to train the initial vehicle accident occurrence frequency calculation model using a machine learning method; and
defining the trained initial vehicle accident occurrence frequency calculation model as the pre-trained vehicle accident occurrence frequency calculation model.

9. The method according to claim 6, wherein the vehicle accident compensation rate calculation model is trained and obtained by:
acquiring an initial vehicle accident compensation rate calculation model and a predetermined third sample data set, wherein each piece of sample data in the third sample data set comprises at least one personal attribute characteristic of a user and a historical vehicle accident compensation rate of the user;
using the at least one personal attribute characteristic of the user in each piece of sample data in the third sample data set as input data, and the historical vehicle accident compensation rate of the user in the sample data as corresponding output data to train the initial vehicle accident compensation rate calculation model using a machine learning method; and
defining the trained initial vehicle accident compensation rate calculation model as the pre-trained vehicle accident compensation rate calculation model.

10. An apparatus for outputting information, the apparatus comprising:
at least one processor; and
a memory storing instructions, the instructions when executed by the at least one processor, cause the at least one processor to perform operations, the operations comprising:
acquiring at least one personal attribute characteristic of a target user;
determining, based on the acquired at least one personal attribute characteristic, a user type of the target user under a preset attribute; and
outputting the determined user type.

11. The apparatus according to claim 10, wherein the at least one personal attribute characteristic comprises at least one of: a natural personal attribute characteristic or a network behavior characteristic, and the network behavior characteristic comprises at least one of: an electronic map navigation characteristic, an interests profile characteristic, an address characteristic, a common application characteristic, a credit score characteristic or a network search topic characteristic.

12. The apparatus according to claim 11, wherein the determining, based on the acquired at least one personal attribute characteristic, a user type of the target user under a preset attribute comprises:
importing the acquired at least one personal attribute characteristic into a pre-trained user type determination model to obtain the user type of the target user under the preset attribute, wherein the user type determination model is used to represent a corresponding relationship between the at least one personal attribute characteristic and the user type.

13. The apparatus according to claim 11, wherein the user type comprises a first user type and a second user type.

14. The apparatus according to claim 13, wherein the determining, based on the acquired at least one personal attribute characteristic, a user type of the target user under a preset attribute comprises:
importing the acquired at least one personal attribute characteristic into a pre-trained vehicle accident occurrence frequency calculation model to obtain a predicted vehicle accident occurrence frequency of the target user, wherein the vehicle accident occurrence frequency calculation model is used to represent a corresponding relationship between the at least one personal attribute characteristic and a vehicle accident occurrence frequency;
determining the user type of the target user under the preset attribute to be the first user type, in response to determining the predicted vehicle accident occurrence frequency being greater than a preset vehicle accident occurrence frequency threshold; and
determining the user type of the target user under the preset attribute to be the second user type, in response to determining the predicted vehicle accident occurrence frequency being not greater than the preset vehicle accident occurrence frequency threshold.

15. The apparatus according to claim 13, wherein the determining, based on the acquired at least one personal attribute characteristic, a user type of the target user under a preset attribute comprises:
importing the acquired at least one personal attribute characteristic into a pre-trained vehicle accident compensation rate calculation model to obtain a predicted vehicle accident compensation rate of the target user, wherein the vehicle accident compensation rate calculation model is used to represent a corresponding relationship between the at least one personal attribute characteristic and a vehicle accident compensation rate;
determining the user type of the target user under the preset attribute to be the first user type, in response to determining the predicted vehicle accident compensation rate being greater than a preset vehicle accident compensation rate threshold; and
determining the user type of the target user under the preset attribute to be the second user type, in response to determining the predicted vehicle accident compensation rate being not greater than the preset vehicle accident compensation rate threshold.

16. The apparatus according to claim 12, wherein the user type determination model is trained and obtained by:
acquiring an initial user type determination model and a predetermined first sample data set, wherein each piece of sample data in the first sample data set comprises at least one personal attribute characteristic of a user and a user type of the user under the preset attribute;
using the at least one personal attribute characteristic of the user in each piece of sample data in the first sample data set as input data, and the user type of the user under the preset attribute in the sample data as corresponding output data to train the initial user type determination model using a machine learning method; and
defining the trained initial user type determination model as the pre-trained user type determination model.

17. The apparatus according to claim 14, wherein the vehicle accident occurrence frequency calculation model is trained and obtained by:
acquiring an initial vehicle accident occurrence frequency calculation model and a predetermined second sample data set, wherein each piece of sample data in the second sample data set comprises at least one personal attribute characteristic of a user and a historical vehicle accident occurrence frequency of the user;
using the at least one personal attribute characteristic of the user in each piece of sample data in the second sample data set as input data, and the historical vehicle accident occurrence frequency of the user in the sample data as corresponding output data to train the initial vehicle accident occurrence frequency calculation model using a machine learning method; and
defining the trained initial vehicle accident occurrence frequency calculation model as the pre-trained vehicle accident occurrence frequency calculation model.

18. The apparatus according to claim 15, wherein the vehicle accident compensation rate calculation model is trained and obtained by:
acquiring an initial vehicle accident compensation rate calculation model and a predetermined third sample data set, wherein each piece of sample data in the third sample data set comprises at least one personal attribute characteristic of a user and a historical vehicle accident compensation rate of the user;
using the at least one personal attribute characteristic of the user in each piece of sample data in the third sample data set as input data, and the historical vehicle accident compensation rate of the user in the sample data as corresponding output data to train the initial vehicle accident compensation rate calculation model using a machine learning method; and
defining the trained initial vehicle accident compensation rate calculation model as the pre-trained vehicle accident compensation rate calculation model.

19. A non-transitory computer storage medium storing a computer program, the computer program when executed by one or more processors, causes the one or more processors to perform operations, the operations comprising:
acquiring at least one personal attribute characteristic of a target user;
determining, based on the acquired at least one personal attribute characteristic, a user type of the target user under a preset attribute; and
outputting the determined user type.
